(19) United States
(12) Patent Application Publication
(10) Pub. No.: US 2011/0141112 A1
(43) Pub. Date: Jun. 16, 2011

(54) Image processing techniques

(76) Inventors: William Allen Hux, Hillsboro, OR (US); Doug W. Mcnabb, Bellevue, WA (US)

(21) Appl. No.: 12/653,296

(22) Filed: Dec. 11, 2009

(51) Int. Cl. G06T 15/60; G09G 5/36

(52) U.S. Cl. 345/426; 345/545

(57) ABSTRACT

Hierarchical culling can be used during shadow generation by using a stencil buffer generated from a light view of the eye-view depth buffer. The stencil buffer indicates which regions visible from an eye-view are also visible from a light view. A pixel shader can determine if any object could cast a shadow by comparing a proxy geometry for the object with visible regions in the stencil buffer. If the proxy geometry does not cast any shadow on a visible region in the stencil buffer, then the object corresponding to the proxy geometry is excluded from a list of objects for which shadows are to be rendered.

### FIELD

The subject matter disclosed herein relates generally to graphics processing, including the determination of which shadows to render.

### RELATED ART

In image processing techniques, shadows are defined for unique objects on a screen. For example, G. Johnson, W. Mark, and C. Burns, “The Irregular Z-Buffer and its Application to Shadow Mapping,” University of Texas at Austin (April 2009) (available at http://www.cs.utexas.edu/ftp/pub/techreports/tr04-09.pdf) describes classical techniques for conventional and irregular shadow mapping of a scene based on light view and eye/camera view depth buffers with respect to its FIG. 4 and accompanying text.

From a light perspective, consider a scene in which a character is standing behind a wall. If the character is completely within the wall's shadow, the character's shadow does not have to be evaluated because the wall's shadow covers the area where the character's shadow would have been. Typically, in a graphics pipeline, all of the character's triangles would be rendered to determine the character's shadow. However, the character's shadow and corresponding light-view depth values would not be relevant for this scene. Relatively expensive vertex processing is used to render the character's triangles and shadows. Known shadow rendering techniques incur the expense of rendering the whole scene during the shadow pass or using application-specific knowledge of object placement.

It is desirable to reduce the amount of processing takes place during shadow rendering.

### BRIEF DESCRIPTION OF THE DRAWINGS

Embodiments of the present invention are illustrated by way of example, and not by way of limitation, in the drawings and in which like reference numerals refer to similar elements.

FIG. 1 depicts an example of a system in which an application requests rendering of scene graphs.

FIG. 2 depicts a suitable graphics pipeline that can be used in embodiments.

FIG. 3 depicts a suitable process that can be used to determine which objects are to have shadows generated.

FIG. 4 depicts another flow diagram of a process to determine which proxy boundary objects to exclude from a list of objects that are to generate shadows.

FIG. 5A depicts an example of stencil buffer creation.

FIG. 5B depicts an example of projecting bounding volumes onto a stencil buffer.

FIG. 6 depicts a suitable system that can use embodiments of the invention.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Various embodiments enable hierarchical culling during shadow generation by using a stencil buffer generated from a light view of the eye-view depth buffer. The stencil buffer may be generated by projecting depth values in a standard plane of a camera view onto a light-view image plane. The stencil buffer is from a light view and indicates points or regions in the eye view that could potentially be in shadow. If nothing is between a point or region and the light source, then the point is lit from the light view. If something is between the point or region and the light source, then the point is in shadow. For example, a region in the stencil buffer may have a “1” value (or other value) if it corresponds to a visible point or region from the eye view. The point or region can be represented by standard plane coordinates.

An application can render simple geometry such as a proxy geometry/bounding volume and use an occlusion query against the stencil buffer to determine if any proxy geometry could have cast a shadow. If not, then potentially expensive processing to render a shadow of an object associated with the proxy geometry can be skipped, thereby potentially reducing the time to generate shadows.

Hierarchical culling can be used such that occlusion queries can be performed for proxy geometries in an order of highest to lowest priority. For example, for a high-resolution character, an occlusion query for the proxy geometry of the whole character can be performed followed by occlusion queries for the limbs and torso of the character. Games often have such proxy geometry available for physics calculations and other uses.

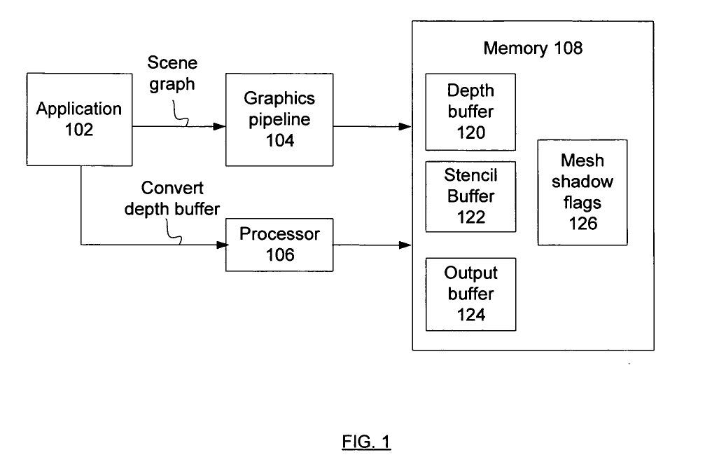

FIG. 1 depicts an example of a system in which application 102 requests rendering of one or more objects. Application 102 can issue a scene graph to graphics pipeline 104 and/or processor 106. The scene graph can include a number of meshes. Each mesh can include references to index buffers, vertex buffers, textures, vertices, connectivity of the vertices, shaders (e.g., the specific geometry, vertex, and pixel shaders to use), textures, and a hierarchy of cruder proxy geometries.

Processor 106 can be single or multiple threads, single or multiple cores, central processing unit, graphics processing unit, or graphics processing unit performing general computing operations. Processor 106 can perform operations of graphics pipeline 104, in addition to other operations.

Application 102 specifies scene graphs, which specific pixel shader to use to generate depth values as opposed to color values, and a camera view matrix (e.g., look, up, side, and field of view parameters) that specifies the view from which to generate the depth values. In various embodiments, graphics pipeline 104 uses its pixel shader (not depicted) to generate a depth buffer 120 for objects in the scene graph provided by application 102 for a camera view matrix. Output merger by graphics pipeline 104 can be skipped. Depth buffer 120 can indicate x, y, z positions of objects in camera space. The z position can indicate a distance of a point from a camera. Depth buffer 120 can be the same size as a color buffer (e.g., screen size). Graphics pipeline 104 stores depth buffer 120 in memory 108.

To generate the depth buffer from a camera/eye space, one or a combination of a processor (e.g., processor or general purpose computing on a graphics processing unit), pixel shader in a graphics pipeline (e.g., software executed by a processor, and general purpose computing on a graphics processing unit) that outputs depth values can be used.

In some cases, a graphics processor can populate a depth buffer and a color buffer to rasterize pixels. If a graphics processor is used, the operation of generating the color buffer can be disabled. A depth buffer can be populated to determine pixel rejection, i.e., the graphics processor rejects pixels from the camera perspective that are behind (i.e., further away from) existing pixels from being rendered. The depth buffer stores non-linear depth values related to 1/depth. The depth values can be normalized to a range. Use of a processor may reduce memory usage and is generally faster when rendering a color buffer is disabled.

In the case where a pixel shader generates a depth buffer, the pixel shader generates depth values. Use of a pixel shader can permit storage of linearly-interpolated depth values. Shadow mapping visual artifacts can be reduced by using linearly-interpolated depth values.

A depth buffer in a scene graph contains the visible points of all objects in a scene from the eye view. After depth buffer 120 is available, application 102 instructs processor 106 to convert depth buffer 120 from camera space to light space. Processor 106 can determine a stencil buffer by projecting depth values from a camera-view onto a light-view image plane. Projection can be performed using matrix multiplication. Processor 106 stores depth buffer 120 from light space in memory 108 as stencil buffer 122. Stencil buffer 122 includes a light view perspective of all visible points from the eye view. In some cases, stencil buffer 122 can overwrite the depth buffer or can be written to another buffer in memory.

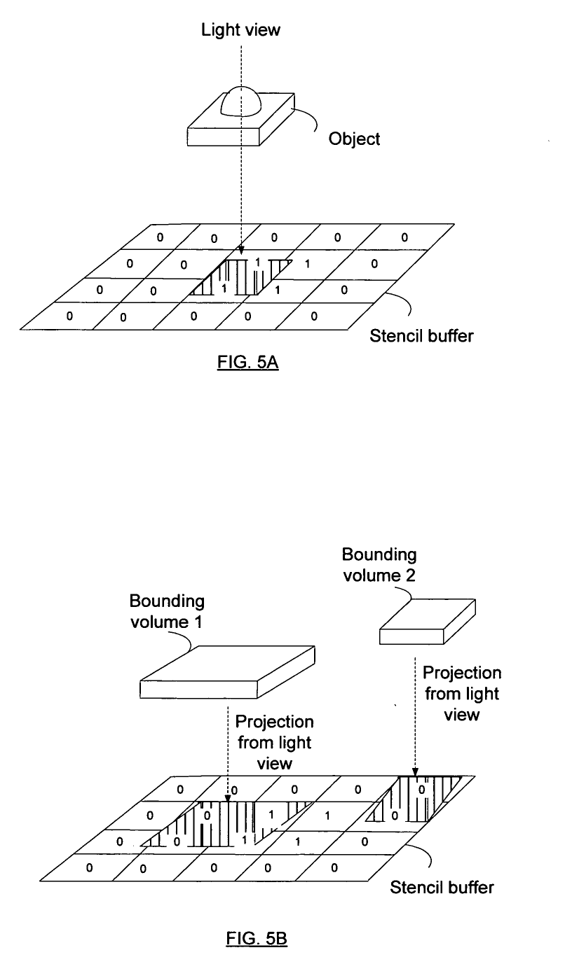

In various embodiments, stencil buffer 122 indicates points or regions in the camera/eye view that are visible from the light view provided no that no other object casts a shadow on that object. In one embodiment, a stencil buffer is initialized to all zeros. If a pixel from an eye/camera view is visible from the light view, then a “1” is stored in a portion of the stencil buffer associated with that region. FIG. 5A depicts an example of a stencil buffer based on visibility of an object from the eye view. The “1”s are stored in the regions that are visible from the light view. For example, a region can be 4 pixel by 4 pixel region. As will be described in more detail later, when rasterizing a scene from the light view, 4 pixel by 4 pixel regions of objects in a scene that map to empty regions in the stencil buffer can be excluded from regions that are to have shadows drawn.

The convention could be reversed so that a “0” indicates visibility from the light view and a “1” indicates no visibility from the light view.

The stencil buffer can be a two-dimensional array. A stencil buffer can be sized such that a byte in the stencil buffer corresponds to a 4 pixel by 4 pixel region in the light-view render target. The byte size can be chosen to match the minimum size that a scatter instruction can reference. A scatter instruction distributes stored values to multiple destinations. By contrast, a traditional store instruction distributes values to sequential/contiguous addresses. For example, a software rasterizer may operate on 16 pixels at a time to maximize performance, due to its 16-wide SIMD instruction set.

The stencil buffer could be any size. A smaller sized stencil buffer would be faster to generate and use but be overly conservative, whereas larger sizes would be more precise at the cost of more time to create and more memory footprint. For example, if the stencil buffer were 1 bit, then mapping a scene to any empty region in the stencil buffer would unlikely to produce any portion of the scene that can be skipped from shadowing. If the stencil buffer were higher resolution, then scanning multiple pixels in the stencil buffer would take place to determine which portions of a scene do not generate a shadow. Performance tuning could lead to the most optimal stencil buffer resolution for a given application.

For example, a rendered proxy geometry resulting from projecting a 3D object from a scene onto the 2D stencil buffer could cover 100×100 pixels.

After a stencil buffer is available for use, application 102 can request generating simple proxy geometries or bounding volumes (e.g., rectangle, sphere, or convex hulls) to represent objects in the same scene graph used to generate the depth buffer and stencil buffer. For example, if the object is a tea pot, the object could be represented using one or more bounding volumes or some three-dimensional volume that encloses the object but has less detail than the enclosed object. If the object is a person, the head could be represented as a sphere and the trunk and each limb could be represented by a bounding volume or some three-dimensional volume that encloses the object but has less detail than the enclosed object.

In addition, application 102 can identify one or more scene graphs (the same scene graphs used for both camera and light view to generate the stencil buffer) and request graphics pipeline 104 to determine whether each region in bounding volumes of the scene graphs maps onto a corresponding region in the stencil buffer. In this case, bounding volumes for each object in a scene graph is used to determine whether the enclosed object casts a shadow on an object projected to the light view and visible from the eye view. By contrast, determination of the depth buffer and stencil buffer considered the object as opposed to its bounding volume.

Graphics pipeline 104 uses one or more pixel shaders to map portions of bounding volumes onto corresponding portions of the stencil buffer. From the light view, each bounding volume in the scene graph can be mapped to corresponding regions the stencil buffer. From the light view, if an object's bounding volume does not cover any region of the stencil buffer marked as a “1”, then that object cannot cast a shadow on an object visible from the eye view. Accordingly, the object is excluded from shadow rendering.

In various embodiments, for each object in the scene graph, the proxy geometry is rendered from the light view using graphics pipeline 104 and the pixel shader reads the stencil buffer to determine whether a proxy geometry has shadows.

FIG. 5B depicts an example of projecting bounding volumes onto a stencil buffer generated with regard to FIG. 5A. Both bounding volumes 1 and 2 were not visible from the light view transformation from the eye view that resulted in the stencil buffer. In this example, bounding volume 1 projects onto 1's in the stencil buffer from the light view and accordingly the corresponding object is not eliminated from objects for which shadows may be rendered. Bounding volume 2 projects onto 0's in the stencil buffer. Accordingly, the object associated with bounding volume 2 can be excluded from shadow rendering.

Referring to FIG. 1, output buffer 124 can be initialized to zero. If any region covers a depth buffer with a “0”, then the output buffer is not written to. If any region covers a depth buffer with a “1”, then the output buffer is written with a “1”. Parallel processing of different regions of the same object can take place at the same time. If the output buffer is written to “1” at any time, then the object associated with the bounding volume is not eliminated from shadow rendering.

In some cases, output buffer 124 can be the sum of values in the stencil buffer. Accordingly, if the output buffer is ever greater than zero, the corresponding object is not eliminated from shadow rendering.

In another scenario, an output buffer can be multiple bits in size and have multiple portions. A first pixel shader could map a first portion of the proxy geometry to a corresponding portion of the stencil buffer and write a “1” to a first portion of output buffer 124 if the first portion of the proxy geometry maps to a “1” in the stencil buffer or write a “0” if the first portion of the proxy geometry maps to a “0” in the stencil buffer. In addition, in parallel, a second pixel shader could map a second portion of the same proxy geometry to a corresponding portion of the stencil buffer and write a “1” to a second portion of output buffer 124 if any portion of the proxy geometry maps to a “1” in the stencil buffer or write a “0” if the second portion of the proxy geometry maps to a “0” in the stencil buffer. The results in output buffer 124 can be OR'd together and if the output is a “0”, then the proxy geometry does not generate a shadow and is excluded from a list of proxy objects for which shadows are to be generated. If the OR'd together outputs from output buffer 124 result in a “1,” then the proxy object cannot be excluded from a list of proxy objects for which shadows are to be generated. Once populated, the stencil buffer contents can be reliably accessed in parallel without contention.

The graphics processing unit or processor rasterizes bounding volumes at the same resolution as that of the stencil buffer. For example, if the stencil buffer has a resolution of 2×2 pixel regions, then the bounding volume is rasterized at 2×2 pixel regions and so forth.

After determining which objects to exclude from shadow rendering, application 102 (FIG. 1) provides the same scene graph used to determine the stencil buffer and exclude objects from shadow rendering to graphics pipeline 104 to generate shadows. Any object whose bounding volume mapped to a “1” in the stencil buffer is excluded from a list of proxy objects for which shadows are to be generated. In this case, objects in a scene graph as opposed to bounding volumes are used to generate shadows. If any bounding volume in a mesh projects a shadow on a visible region of the stencil buffer, then the whole mesh is evaluated for shadow rendering. Mesh shadow flags 126 can be used to indicate which meshes are to have shadows rendered.

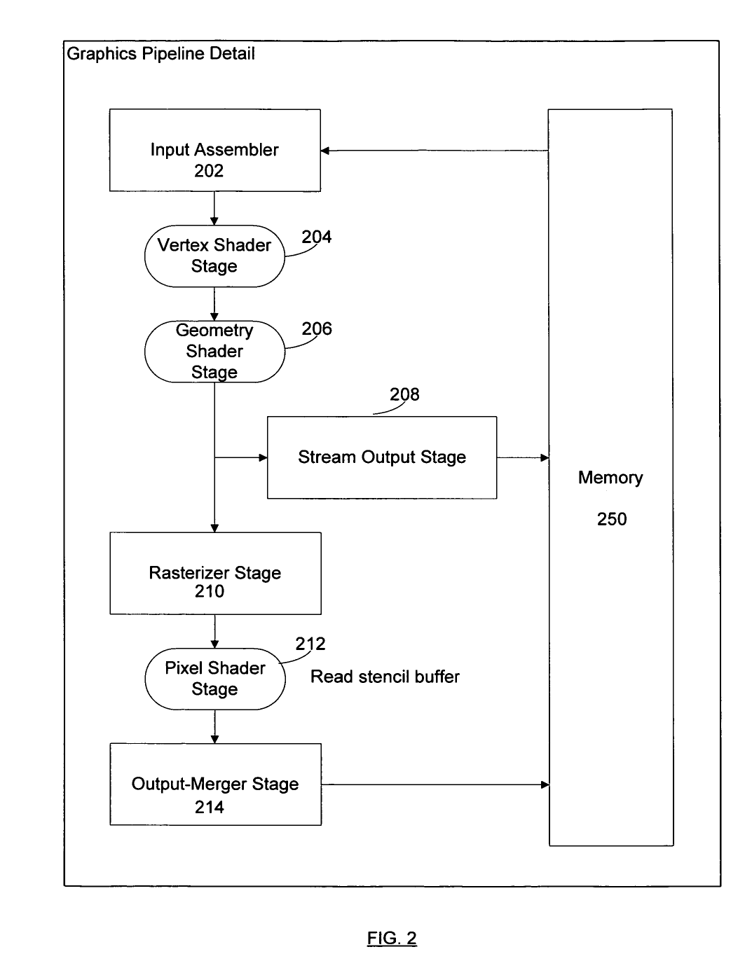

FIG. 2 depicts a suitable graphics pipeline that can be used in embodiments. The graphics pipeline can be compatible with Segal, M. and Akeley, K., “The OpenGL Graphics System: A Specification (Version 2.0)” (2004), The Microsoft DirectX 9 Programmable Graphics Pipe-line, Microsoft Press (2003), and Microsoft® DirectX 10 (described for example in D. Blythe, “The Direct3D 10 System,” Microsoft Corporation (2006)) as well as variations thereof. DirectX is a group of application program interfaces (APIs) involved with input devices, audio, and video/graphics.

In various embodiments, all stages of the graphics pipeline can be configured using one or more application program interfaces (API). Drawing primitives (e.g., triangles, rectangles, squares, lines, point, or shapes with at least one vertex) flow in at the top of this pipeline and are transformed and rasterized into screen-space pixels for drawing on a computer screen.

Input-assembler stage 202 is to collect vertex data from up to eight vertex buffer input streams. Other numbers of vertex buffer input streams can be collected. In various embodiments, input-assembler stage 202 may also support a process called “instancing,” in which input-assembler stage 202 replicates an object several times with only one draw call.

Vertex-shader (VS) stage 204 is to transform vertices from object space to clip space. VS stage 204 is to read a single vertex and produce a single transformed vertex as output.

Geometry shader stage 206 is to receive the vertices of a single primitive and generate the vertices of zero or more primitives. Geometry shader stage 206 is to output primitives and lines as connected strips of vertices. In some cases, geometry shader stage 206 is to emit up to 1,024 vertices from each vertex from the vertex shader stage in a process called data amplification. Also, in some cases, geometry shader stage 206 is to take a group of vertices from vertex shader stage 204 and combine them to emit fewer vertices.

Stream-output stage 208 is to transfer geometry data from geometry shader stage 206 directly to a portion of a frame buffer in memory 250. After the data moves from stream-output stage 208 to the frame buffer, data can return to any point in the pipeline for additional processing. For example, stream-output stage 208 may copy a subset of the vertex information output by geometry shader stage 206 to output buffers in memory 250 in sequential order.

Rasterizer stage 210 is to perform operations such as clipping, culling, fragment generation, scissoring, perspective dividing, viewport transformation, primitive setup, and depth offset.

Pixel shader stage 212 is to read properties of each single pixel fragment and produce an output fragment with color and depth values. In various embodiments, pixel shader 212 is selected based on the instructions from the application.

As the proxy geometry is rasterized, a pixel shader looks up the stencil buffer based on the pixel position of the bounding volume. The pixel shader can determine if any of the bounding volume could have resulted in a shadow by comparing each region in the bounding volume with the corresponding region in the stencil buffer. If all of the regions in the stencil buffer corresponding to regions of the bounding volume indicate no shadow is cast on a visible object, then the object corresponding to the bounding volume is excluded from a list of objects for which shadows are to be rendered. Accordingly, embodiments provide for identifying and excluding objects from a list of bounding volumes for which shadows are to be rendered. If an object does not cast a shadow on a visible object, then potentially expensive high-resolution shadow computation and rasterization operations can be skipped.

Output merger stage 214 is to perform stencil and depth testing on fragments from pixel shader stage 212. In some cases, output merger stage 214 is to perform render target blending.

Memory 250 can be implemented as any or a combination of: a volatile memory device such as but not limited to a Random Access Memory (RAM), Dynamic Random Access Memory (DRAM), Static RAM (SRAM), or any other type of semiconductor-based memory or magnetic memory.

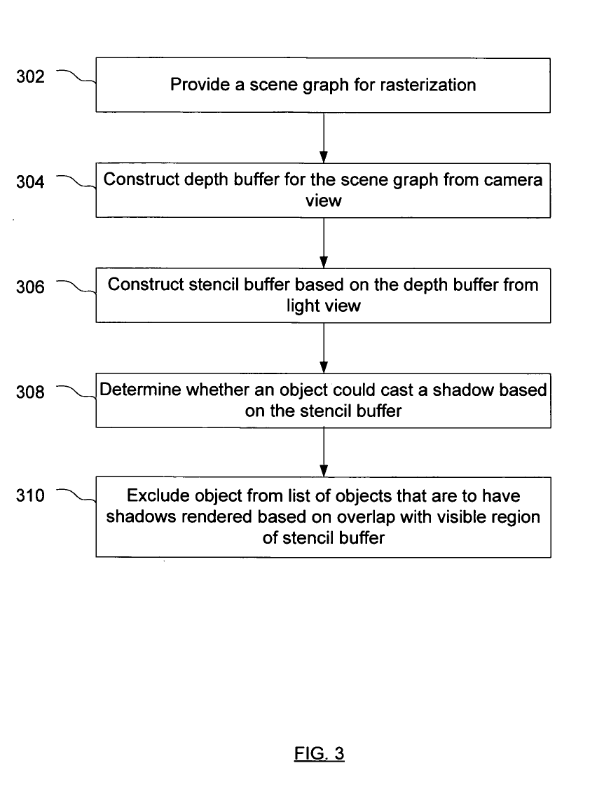

FIG. 3 depicts a suitable process that can be used to determine which objects in a scene are to have shadows generated.

Block 302 includes providing a scene graph for rasterization. For example, an application can provide the scene graph to a graphics pipeline for rasterization. The scene graph can describe a scene that is to be displayed using meshes, vertices, connectivity information, selection of shaders used to rasterize the scene, and bounding volumes.

Block 304 includes constructing a depth buffer for the scene graph from a camera view. The pixel shader of the graphics pipeline can be used to generate the depth values of objects in the scene graph from the specified camera view. The application can specify that the pixel shader is to store depth values of the scene graph and specify the camera view using a camera view matrix.

Block 306 includes generating a stencil buffer based on the depth buffer from the light view. Matrix mathematics can be used to convert the depth buffer from camera space to light space. The application can instruct a processor, graphics processor, or request general purpose computing on a graphics processor to convert the depth buffer from camera space to light space. The processor stores the resulting depth buffer from light space in memory as the stencil buffer. Various possible implementations of the stencil buffer are described with regard to FIGS. 1 and 5A.

Block 308 can include determining whether an object from the scene graph provided in block 302 could cast a shadow based on content of the stencil buffer. For example, a pixel shader can compare each region in a proxy geometry for an object with the corresponding region in the stencil buffer. If any region in the proxy geometry overlaps with a “1” in the stencil buffer, that proxy geometry casts a shadow and the corresponding object is not excluded from shadow rendering. If a proxy geometry does not overlap with any “1” in the stencil buffer, that proxy geometry is excluded from shadow rendering in block 310.

Blocks 308 and 310 can repeat until all proxy geometry objects are inspected. For example, an order can be set in which objects are examined to determine if they cast shadows. For example, for a high-resolution human-shaped figure, a bounding box of the entire human figure is examined and then the bounding boxes of the limbs and torso are next examined. If no shadow is cast from any portion of a proxy geometry of a human figure, then the proxy geometries of the limbs and torso of the figure can be skipped. However, if a shadow is cast from a portion of a proxy geometry of a human figure, then other sub-geometries of the human figure are inspected to determine whether a shadow is cast by any portion. Accordingly, shading of some sub-geometries may be skipped to save memory and processing resources.

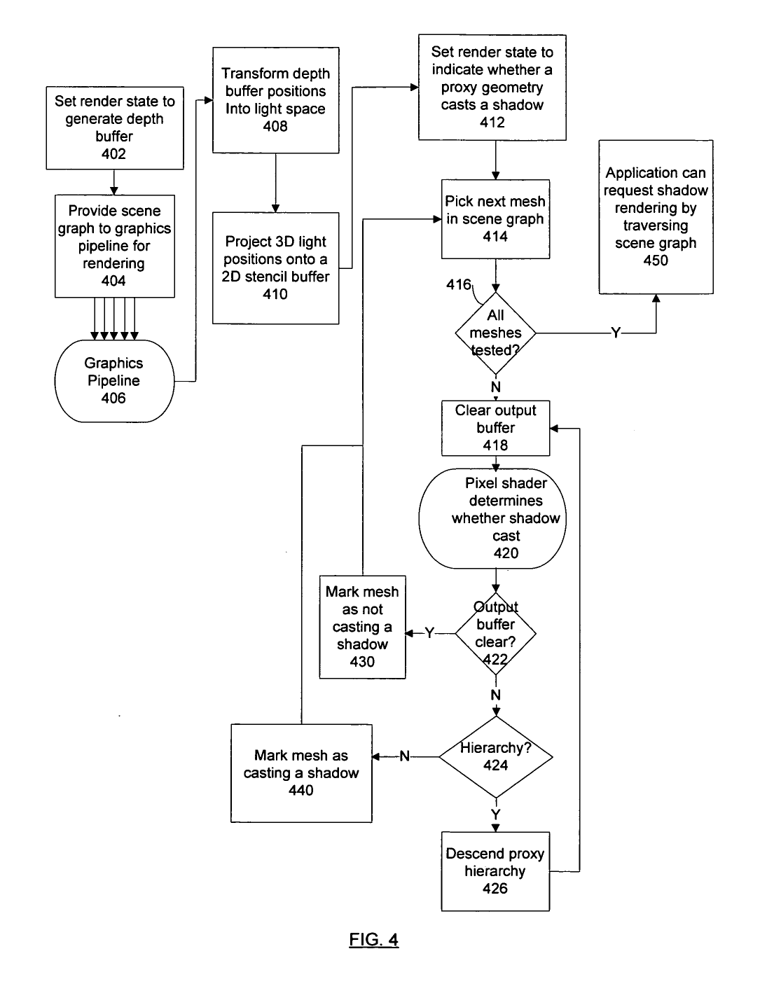

FIG. 4 depicts another flow diagram of a process to determine which proxy boundary objects to exclude from a list of objects that are to have shadows rendered.

Block 402 includes setting the render state for a scene graph. An application can set the render state by specifying that the pixel shader write depth values of a scene graph from a particular camera view. The application provides the camera view matrix to specify the camera view.

Block 404 includes the application providing the scene graph to the graphics pipeline for rendering.

Block 406 includes the graphics pipeline processing input meshes based on the specified camera view transforms and storing a depth buffer into memory. Scene graphs can be processed by the graphics pipeline in parallel. Many stages of the pipeline can be parallelized. Pixel processing can occur in parallel with vertex processing.

Block 408 includes transforming depth buffer positions into light space. An application can request a processor to convert the x, y, z coordinates of the depth buffer from the camera space to x, y, z coordinates in the light space.

Block 410 includes projecting three dimensional light positions onto a two dimensional stencil buffer. The processor can convert the x, y, z positions in light space to a two dimensional stencil buffer. For example, matrix mathematics can be used to convert the positions. The stencil buffer can be stored in memory.

Block 412 includes the application programming the graphics pipeline to indicate whether a proxy geometry casts a shadow. The application can select pixel shaders for a scene graph that is to read the stencil buffer. In parallel, the selected pixel shaders compare positions in a proxy geometry with corresponding positions in the stencil buffer. Pixel shaders are to read stencil values from a region in the stencil buffer and write 1 to an output buffer if any corresponding region in the proxy geometry also has a 1. Various embodiments of the stencil buffer and uses of the stencil buffer to determine shadow generation by proxy geometries are described with regard to FIGS. 1, 5A, and 5B.

Block 414 includes selecting a next mesh in a scene graph.

Block 416 includes determining whether all meshes have been tested against the stencil buffer. If all meshes have been tested, block 450 follows block 416. If all meshes have not been tested, block 418 follows block 416.

Block 418 includes clearing the output buffer. The output buffer indicates whether a bounding volume geometry casts any shadow. If the output buffer is non-zero, then a shadow may be cast by object associated with bounding volume. When rendered the actual object as opposed to the bounding volume is used to render a shadow, then whether a shadow is cast is known. In some cases, the object does not cast a shadow even though comparison between the bounding volume and the stencil buffer indicate a shadow is cast.

Block 420 includes the selected pixel shader determining whether a proxy geometry casts any shadow. The pixel shader follows the command from block 412 to store a 1 to the output buffer if a corresponding position in a proxy geometry corresponds to a 1 in the stencil buffer. Multiple pixel shaders can operate in parallel to compare different portions of the proxy geometry with corresponding positions in the stencil buffer in the manner described with regard to FIG. 1.

Block 422 includes determining whether the output buffer is clear. An output buffer is clear if it indicates none of the proxy geometries map to any 1 in the stencil buffer. If the output buffer is clear after executing block 420, then the mesh is marked as not casting a shadow in block 430. If the output buffer is not clear after executing block 420, block 424 follows block 422.

Block 424 includes determining whether a mesh hierarchy is specified for the mesh. An application specifies the mesh hierarchy. If a hierarchy is specified, block 426 follows block 424. If a hierarchy is not specified, block 440 follows block 424.

Block 426 includes selecting a next highest priority proxy geometry and then repeating block 418. Block 418 is performed for the next highest priority proxy geometry.

Block 440 includes marking a mesh as casting a shadow. If any bounding box in mesh has a projected shadow based on corresponding locations in the stencil buffer, then all objects in the mesh are to be considered for shadow rendering.

Block 450 includes the application permitting generating of shadows. The meshes that do not generate shadows are excluded from a list of objects that could generate shadows. If any bounding box in a mesh projects a shadow on the stencil buffer, then the whole mesh is evaluated for shadow rendering.

In some embodiments, forming a stencil buffer can take in place in conjunction with forming an irregular z buffer (IZB) light-view representation. The underlying data structure of irregular shadow mapping is a grid, but the grid stores a list of projected pixels at sub-pixel resolution for each pixel in the light view. IZB shadow representations can be created by the following process.

(1) Rasterize the scene from the eye view, storing only the depth values.

(2) Project the depth values onto light-view image plane and store the sub-pixel accurate position in per-pixel list of samples (zero or more eye-view points may map to the same light-view pixel). This is the data structure construction phase and during this data structure construction phase, a bit is set in a 2D stencil buffer as each eye-view value is projected into light space. Multiple pixels may correspond to the same stencil buffer location, but can store a single “1”.

A grid-distribution stencil buffer can be generated during (2) that indicates regions of IZB that have no pixel values. Regions that have pixel values are compared with a bounding volume to determine whether a shadow may be cast by the bounding volume.

(3) Render the geometry from the light view, testing against the stencil buffer created in (2). If a sample in the stencil buffer is within the edges of a light-view object, but behind the object relative to the light (i.e., further away from the object), then the sample is in shadow. Shadowed samples are marked accordingly. When rasterizing the geometry from the light view in (3), regions can be skipped that map to empty regions in the stencil buffer, because there will be no eye-view samples to test against in that region of the IZB data structure.

(4) Render the scene again from the eye view, but use the shadow information resulting from step (3).

Because many shadowing techniques (other than IZB) have various artifacts due to imprecision and aliasing, the proxy geometry could be expanded (e.g. via a simple scale factor) or the stencil buffer dilated to make the test more conservative and thereby avoid introducing even more artifacts.

In some embodiments, a stencil buffer can store depth values from the light view instead of 1's and 0's. For a region, if the depth value in the stencil buffer is larger than the distance from the light view plane to the bounding volume (i.e., the bounding volume is closer to the light source than the object recorded in the stencil buffer), then the bounding volume casts a shadow on the region. For a region, if the depth value in the stencil buffer is less than the distance from the light view plane to the bounding volume (i.e., the bounding volume is further from the light source than the object recorded in the stencil buffer), then the bounding volume does not cast a shadow on the region and the associated object can be excluded from objects that are to have shadow rendered.

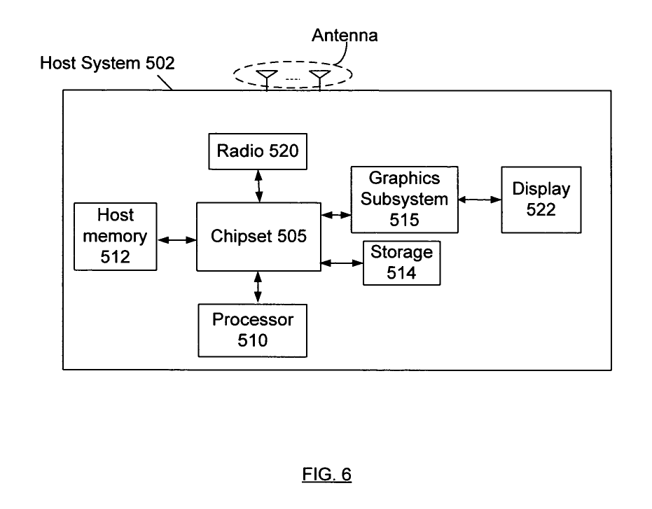

FIG. 6 depicts a suitable system that can use embodiments of the invention. Computer system may include host system 502 and display 522. Computer system 500 can be implemented in a handheld personal computer, mobile telephone, set top box, or any computing device. Host system 502 may include chipset 505, processor 510, host memory 512, storage 514, graphics subsystem 515, and radio 520. Chipset 505 may provide intercommunication among processor 510, host memory 512, storage 514, graphics subsystem 515, and radio 520. For example, chipset 505 may include a storage adapter (not depicted) capable of providing intercommunication with storage 514. For example, the storage adapter may be capable of communicating with storage 514 in conformance with any of the following protocols: Small Computer Systems Interface (SCSI), Fibre Channel (FC), and/or Serial Advanced Technology Attachment (S-ATA).

In various embodiments, computer system performs techniques described with regard to FIGS. 1-4 to determine which proxy geometries are to have shadows rendered.

Processor 510 may be implemented as Complex Instruction Set Computer (CISC) or Reduced Instruction Set Computer (RISC) processors, multi-core, or any other microprocessor or central processing unit.

Host memory 512 may be implemented as a volatile memory device such as but not limited to a Random Access Memory (RAM), Dynamic Random Access Memory (DRAM), or Static RAM (SRAM). Storage 514 may be implemented as a non-volatile storage device such as but not limited to a magnetic disk drive, optical disk drive, tape drive, an internal storage device, an attached storage device, flash memory, battery backed-up SDRAM (synchronous DRAM), and/or a network accessible storage device.

Graphics subsystem 515 may perform processing of images such as still or video for display. An analog or digital interface may be used to communicatively couple graphics subsystem 515 and display 522. For example, the interface may be any of a High-Definition Multimedia Interface, DisplayPort, wireless HDMI, and/or wireless HD compliant techniques. Graphics subsystem 515 could be integrated into processor 510 or chipset 505. Graphics subsystem 515 could be a stand-alone card communicatively coupled to chipset 505.

Radio 520 may include one or more radios capable of transmitting and receiving signals in accordance with applicable wireless standards such as but not limited to any version of IEEE 802.11 and IEEE 802.16.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Embodiments of the present invention may be implemented as any or a combination of: one or more microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

The drawings and the forgoing description gave examples of the present invention. Although depicted as a number of disparate functional items, those skilled in the art will appreciate that one or more of such elements may well be combined into single functional elements. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A computer-implemented method comprising:
requesting determination of a depth buffer of a scene based on a camera view;
requesting transformation of the depth buffer to a stencil buffer from a light view, the stencil buffer identifying visible regions of the scene from the light view;
determining whether any region in a proxy geometry casts a shadow on a visible region in the stencil buffer;
selectively excluding the proxy geometry from shadow rendering in response to any region in the proxy geometry casting a shadow on a visible region in the stencil buffer; and
rendering shadow of an object corresponding to a proxy geometry not excluded from shadow rendering.

2. The method of claim 1, wherein the requesting determination of a depth buffer of a scene comprises:
requesting a pixel shader to generate depth values of the depth buffer from a scene graph based on a particular camera view.

3. The method of claim 1, wherein the requesting transformation of the depth buffer comprises:
specifying a processor to convert the depth buffer from camera view to a light view.

4. The method of claim 1, further comprising:
selecting a highest priority proxy geometry, wherein the determining whether any region in a proxy geometry projects a shadow on a visible region in the stencil buffer comprises determining whether any region in the highest priority proxy geometry projects a shadow on a visible region in the stencil buffer.

5. The method of claim 4, wherein the highest priority proxy geometry comprises a bounding volume for a multi-part object and further comprising:
excluding any proxy geometry associated with each part of the multi-part object in response to the highest priority proxy geometry not projecting a shadow on a visible region in the stencil buffer.

6. The method of claim 4, wherein the highest priority proxy geometry comprises a bounding volume for a multi-part object and further comprising:
in response to the highest priority proxy geometry projecting a shadow on a visible region in the stencil buffer, determining whether each proxy geometry associated with each part of the multi-part object projects a shadow on a visible region in the stencil buffer.

7. The method of claim 1, further comprising:
in response to any proxy geometry in a mesh projecting a shadow on a visible region in the stencil buffer, determining whether each proxy geometry associated with the mesh projects a shadow on a visible region in the stencil buffer.

8. An apparatus comprising:
an application requesting rendering of a scene graph;
pixel shader logic to generate a depth buffer of the scene graph from an eye view;
a processor to convert the depth buffer to a stencil buffer based on a light view;
a memory to store the depth buffer and the stencil buffer;
one or more pixel shaders to determine whether portions of bounding volumes cast shadows onto visible regions indicated by the stencil buffer and to selectively exclude an object associated with a bounding volume that casts a shadow on a visible region; and
logic to render a shadow of an object corresponding to a bounding volume not excluded from shadow rendering.

9. The apparatus of claim 8, wherein the application specifies the pixel shader to use.

10. The apparatus of claim 8, wherein the one or more pixel shaders are to:
select a highest priority bounding volume, wherein to determine whether portions of bounding volumes cast shadows onto visible regions indicated by the stencil buffer, the one or more pixel shaders are to determine whether any region in the highest priority bounding volume projects a shadow on a visible region in the stencil buffer.

11. The apparatus of claim 10, wherein the highest priority bounding volume comprises a bounding volume for a multi-part object and wherein the one or more pixel shaders are to:
identify any bounding volume associated with each part of the multi-part object for exclusion from shadow rendering in response to the highest priority bounding volume not projecting a shadow on a visible region in the stencil buffer.

12. The apparatus of claim 10, wherein the highest priority bounding volume comprises a bounding volume for a multi-part object and wherein the one or more pixel shaders are to:
in response to the highest priority bounding volume projecting a shadow on a visible region in the stencil buffer, determine whether each bounding volume associated with each part of the multi-part object projects a shadow on a visible region in the stencil buffer.

13. The apparatus of claim 8, wherein the one or more pixel shaders are to:
determine whether each bounding volume associated with a mesh projects a shadow on a visible region in the stencil buffer in response to any bounding volume in the mesh projecting a shadow on a visible region in the stencil buffer.

14. A system comprising:
a display device;
a wireless interface; and
a host system communicatively coupled to the display device and communicatively coupled to the wireless interface, the host system comprising:
logic to request rendering of a scene graph,
logic to generate a depth buffer of the scene graph from an eye view;
logic to convert the depth buffer to a stencil buffer based on a light view;
a memory to store the depth buffer and the stencil buffer;
logic to determine whether portions of bounding volumes cast shadows onto visible regions indicated by the stencil buffer and to selectively exclude an object associated with a bounding volume that casts a shadow on a visible region;
logic to render a shadow of an object corresponding to a bounding volume not excluded from shadow rendering; and
logic to provide the rendered shadow for display on the display.

15. The system of claim 14, wherein the logic to determine whether portions of bounding volumes cast shadows is to:
select a highest priority bounding volume, wherein to determine whether portions of bounding volumes cast shadows onto visible regions indicated by the stencil buffer, the one or more pixel shaders are to determine whether any region in the highest priority bounding volume projects a shadow on a visible region in the stencil buffer.

16. The system of claim 14, wherein the highest priority bounding volume comprises a bounding volume for a multi-part object and wherein the logic to determine whether portions of bounding volumes cast shadows is to:
identify any bounding volume associated with each part of the multi-part object for exclusion from shadow rendering in response to the highest priority bounding volume not projecting a shadow on a visible region in the stencil buffer.

17. The system of claim 14, wherein the highest priority bounding volume comprises a bounding volume for a multi-part object and wherein the logic to determine whether portions of bounding volumes cast shadows is to:
in response to the highest priority bounding volume projecting a shadow on a visible region in the stencil buffer, determine whether each bounding volume associated with each part of the multi-part object projects a shadow on a visible region in the stencil buffer.
